(19) United States
(12) Patent Application Publication
(10) Pub. No.: US 2020/0247965 A1
(43) Pub. Date: Aug. 6, 2020

(54) LOW-FRICTION FILM, METHOD OF PRODUCING SAME, MOLDED ARTICLE, AND METHOD OF IMPROVING FINGER SLIDABILITY

(71) Applicant: Daicel Corporation, Osaka-shi, Osaka (JP)

(72) Inventor: Yoshitaka SUGAWARA, Tokyo (JP)

(73) Assignee: Daicel Corporation, Osaka-shi, Osaka (JP)

(21) Appl. No.: 16/629,406

(22) PCT Filed: Oct. 11, 2018
(86) PCT No.: PCT/JP2018/037831

§ 371 Date: Jan. 8, 2020

(30) Foreign Application Priority Data
Oct. 25, 2017 (JP) 2017-206410

(51) Int. Cl. C08J 5/18; B32B 7/022; B32B 27/08

(52) U.S. Cl. CPC C08J 5/18; B32B 7/022; B32B 2457/208; B32B 2307/538; B32B 2307/412; B32B 27/08

(57) ABSTRACT

Prepared is a film having at least one surface having a kurtosis (Rku) of greater than or equal to 2 and total height (Rt) of greater than or equal to 1μm.

The dynamic friction coefficient of the surface may be less than or equal to 0.25, and the relative dynamic friction coefficient may be less than or equal to 0.3.

The film includes a low-friction layer formed of a cured product of a curable composition including a curable resin, and the surface of the low-friction layer may have an Rku and an Rt within the range mentioned above.

The curable resin may include at least one selected from the group consisting of a (meth)acrylic polymer having a polymerizable group, a urethane (meth)acrylate, and a silicone (meth)acrylate.

The curable composition may further include a cellulose ester.

The curable composition may be free of fine particles.

The film can reduce the dynamic friction coefficient even if the surface of the film is formed of a wide range or materials.

### TECHNICAL FIELD

The present invention relates to a low-friction film for covering the surface of various molded articles such as touch panel displays, housings of consumer electronic products, or building materials, a method of producing the low friction film, a molded article, and a method of improving the slidability (particularly finger slidability) of the film.

### BACKGROUND ART

In order to prevent scratches on or to improve tactile feel of surfaces of various molded articles such as touch panel displays of personal computers (PC) or smart phones, housings of consumer electronic products, building materials, or the like, a method of applying a hard coat film or a method of performing hard coat treatment to form a surface-protecting layer or a covering layer is known.

Excellent slidability of the hard coat film or the hard coat layer when touched by hand is desired, and typically, as a method of improving the slidability, it is common to perform hard coat treatment which include a silicone compound or a fluorine compound.

JP 2007-264281 A (Patent Document 1) discloses a hard coat layer used in an optical laminate including a silicon-based compound, a fluorine-based compound, or a mixture thereof as an antifouling agent and/or a lubricant, wherein, according to XPS analysis of the uppermost surface of the hard coat layer, the abundance ratio of silicon atom is at least 10% and/or the abundance ratio of fluorine atom is at least 20%.

Additionally, WO 2008/038714 (Patent Document 2) discloses an optically functional film including a substrate, an optically functional layer superimposed on the substrate, and an antifouling layer formed on the optically functional layer, wherein at a surface of the antifouling layer, an element ratio of Si/C is from 0.25 to 1, Si/C being a ratio of silicon element (Si) to carbon element (C), and an element ratio of F/C is from 0.1 to 1 F/C, F/C being a ratio of fluorine element (F) to carbon element (C); the antifouling layer has a liquid paraffin contact angle and a liquid paraffin fall angle of 65° or greater and 15° or below, a black marking ink contact angle and a black marking ink fall angle of 35° or greater and 15° or below, and a dynamic friction coefficient of less than 0.15.

However, although the friction coefficient of a surface of the hard coat layer and the antifouling layer could be reduced by the silicone compound or the fluorine compound, it is not sufficient; in addition, the finger slidability varies greatly depending on fine differences in the structure of the surface.

In addition, since the surface becomes water repellent, the applications are limited; also, since the surface is leveled by wet coating, it is difficult to control the surface shape using the convection phenomenon.

### CITATION LIST

### Patent Document

Patent Document 1: JP 2007-264281 A (claim 1)

Patent Document 2: WO 2008/038714 (claim 1)

### SUMMARY OF INVENTION

### Technical Problem

Thus, an object of the present invention is to provide a low-friction film that can reduce the dynamic friction coefficient even if the surface of the low-friction film is formed of a wide variety of materials; a molded article; a method of producing the low-friction film; and a method of improving finger slidability of the film.

Also, another object of the present invention is to provide a low-friction film that can improve slidability (particularly finger slidability) without blending a large amount of a silicone compound or a fluorine compound, a method of producing the low-friction film, a molded article, and a method of improving slidability (particularly finger slidability) of the film.

### Solution to Problem

As a result of diligent research to accomplish the tasks described above, the present inventors found that by adjusting the kurtosis (Rku) and total height (Rt) of a surface of the film, the dynamic friction coefficient can be reduced even if the surface is formed of a wide variety of materials. Thus, the present invention was completed.

That is, the film (low-friction film) according to an embodiment of the present invention has at least one surface having an Rku greater than or equal to 2 and an Rt greater than or equal to 1 μm.

The dynamic friction coefficient of the surface may be less than or equal to 0.25, and the relative dynamic friction coefficient may be less than or equal to 0.3.

The film includes a low-friction layer, which is formed of a cured product of a curable composition including a curable resin and is disposed on the outermost layer; also, the surface of the low-friction layer may have an Rku greater than or equal to 2 and an Rt greater than or equal to 1 μm.

The curable resin may include at least one selected from the group consisting of a (meth)acrylic polymer having a polymerizable group, a urethane (meth)acrylate, and a silicone (meth)acrylate.

The curable composition may further include a cellulose ester.

The curable composition may be free of fine particles.

The low-friction layer of the low-friction film may be laminated on a substrate layer formed of a transparent resin.

The film may have an abundance ratio of silicon atom at a surface of less than 10% and an abundance ratio of fluorine atom at a surface of less than 20%.

The present invention also includes a method of producing the film which includes curing a curable composition containing a curable resin.

Moreover, the present invention also includes a molded article which includes the film on a surface.

The molded article may be a touch panel display.

Furthermore, the present invention also includes a method of improving finger slidability of the film, in which the method includes adjusting at least one surface of the film to have the kurtosis (Rku) greater than or equal to 2 and the total height (Rt) greater than or equal to 1 μm.

### Advantageous Effects of Invention

According to an embodiment of the present invention, since Rku and Rt of concavo-convex structures on the surface of the film are adjusted to be within a certain range, the dynamic friction coefficient can be reduced even if the surface of the film is formed of a wide variety of materials.

Thus, the slidability (particularly, finger slidability or tactile feel) of the film can be improved without compounding a large amount of a silicone compound or a fluorine compound.

### Description of Embodiments

Low-Friction film

The film (low-friction film) according to an embodiment of the present invention has at least one surface having an Rku (kurtosis) that is adjusted to greater than or equal to 2; also, the Rt of the surface is adjusted to greater than or equal to 1 μm. Thus, convex portions having a large kurtosis and a large height difference are formed on the surface.

Thus, the contact area is small when a surface of the low-friction film according to an embodiment of the present invention comes into contact with a contact object such as a finger, so it can be presumed that the dynamic friction coefficient can be reduced.

The surface having concavo-convex structures in which the Rku and Rt are adjusted to be within the range mentioned above may be formed on both surfaces; however, the surface is often formed on one surface on the side that comes into contact with a finger.

It is sufficient for the Rku (kurtosis) of the surface to be greater than or equal to 2 (for example from 2 to 100), for example, about from 2.5 to 80 (for example from 3 to 50), preferably about from 3.2 to 30 (for example from 3.3 to 20), and more preferably about from 3.5 to 10 (particularly about from 4 to 5).

When the Rku is too small, the dynamic friction coefficient of the surface cannot be reduced and finger slidability cannot be improved.

It is sufficient for the Rt (total height) of the surface to be greater than or equal to 1 μm (for example from 1 to 30 μm), for example, about from 1.5 to 20 p.m (for example from 2 to 15 μm), preferably about from 2 to 10 μm (for example from 2.5 to 8 μm), and more preferably about from 3 to 5 μm (particularly from 3.5 to 4.5 μm).

When the Rt is too small, the dynamic friction coefficient of the surface cannot be reduced and finger slidability cannot be improved.

Note that in the present specification and claims, Rku and Rt can be measured using an optical surface roughness meter or the like based on JIS B0601, and can be measured in detail by the method described in Examples below.

Since the surface has concavo-convex structures in which the Rku and Rt are adjusted to be within the above range, the dynamic friction coefficient (μk) is low, and the dynamic friction coefficient of the surface may be less than or equal to 0.25. For example, the dynamic friction coefficient of the surface may be about from 0.01 to 0.23, preferably about from 0.03 to 0.2, more preferably about from 0.05 to 0.15 (particularly about from 0.08 to 0.12).

Further, the relative dynamic friction coefficient may be less than or equal to 0.3, and may be, for example, about from 0.01 to 0.29, preferably about from 0.04 to 0.25, and more preferably about from 0.06 to 0.19 (particularly about from 0.1 to 0.15).

Note that in the present specification and claims, the dynamic friction force can be measured using a static and dynamic friction measuring machine, and can be measured in detail by the method described in Examples below.

Meanwhile, the relative dynamic friction coefficient is a value obtained by dividing the dynamic friction force of a film measured at the same load by the dynamic friction force measured using glass as an analyte, and can be measured in detail by the method described in Examples below.

This relative dynamic friction coefficient evaluates the friction properties of the film as a relative value of the dynamic friction force of a glass surface that is stable, and thus is a reliable evaluation metric in which errors due to changes over time of artificial skin are mitigated.

It is sufficient for the low-friction film according to an embodiment of the present invention to have concavo-convex structures in which the Rku and Rt are adjusted to be within the range mentioned above on at least one surface, and the material and structure of the film is not particularly limited.

Since the Rku and Rt of a surface of the low-friction film according to an embodiment of the present invention are adjusted to be within the range mentioned above, the dynamic friction coefficient can be reduced even if a large amount of a silicone compound and a fluorine compound are not included.

Thus, an abundance ratio of silicon atom at a surface of the low-friction film (particularly the surface having an Rku and Rt being within the range mentioned above) may be less than 10%, preferably less than or equal to 5%, and more preferably less than or equal to 1%.

In addition, an abundance ratio of fluorine atom on a surface of the low-friction film (particularly the surface having an Rku and Rt being within the range mentioned above) may be less than 20%, preferably less than or equal to 10%, and more preferably less than or equal to 1%.

Note that in the present specification and claims, abundance ratios of silicon atom and fluorine atom can be measured by a known method using an X-ray Photoelectron Spectroscopy device (XPS).

With regard to the structure, the low-friction film according to an embodiment of the present invention may be, for example, a single-layer film in which the Rku and Rt of at least one surface are adjusted to be within the range mentioned above, or a laminate including a low-friction layer, with the Rku and Rt of a surface of the low-friction layer being adjusted to be within the range mentioned above.

### Single-Layer Film and Low-Friction Layer

The material of the single-layer film and the low-friction layer is not limited to the description above, and can be selected from various types of organic materials (thermoplastic resins, thermosetting resins, photocurable resins, or the like) or inorganic materials (glass, ceramics, metals, or the like); however, from the perspective of productivity and the like, a cured product of a curable composition including a curable resin is preferable.

The curable resin may be either a thermosetting resin or a photocurable resin, but from the perspective of productivity and the like, a (meth)acrylic photocurable resin is widely used.

In addition, (meth)acrylic resins, also having excellent transparency, can be suitably used as a protective film for optical applications such as a touch panel display.

Examples of (meth)acrylic photocurable resins include: multifunctional (meth)acrylates, such as (meth)acrylates having from about 2 to 8 polymerizable groups, of which the examples are pentaerythritol tetra(meth)acrylate, dipentaerythritol penta(meth)acrylate, dipentaerythritol hexa(meth)acrylate, or the like; epoxy (meth)acrylates, such as multifunctional epoxy (meth)acrylates having two or more (meth)acryloyl groups; polyester (meth)acrylates, such as multifunctional polyester (meth)acrylates having two or more (meth)acryloyl groups; urethane (meth)acrylates, such as multifunctional urethane (meth)acrylates having two or more (meth)acryloyl groups; silicone (meth)acrylates, such as multifunctional silicone (meth)acrylates having two or more (meth)acryloyl groups; and (meth)acrylic polymers having a polymerizable group.

These curable resins can be used alone or in combination of two or more.

Among these curable resins, a urethane (meth)acrylate, a silicone (meth)acrylate, a (meth)acrylic polymer having a polymerizable group are preferable, and a (meth)acrylic polymer having a polymerizable group is particularly preferable.

The (meth)acrylic polymer having a polymerizable group may be a polymer in which a polymerizable unsaturated group is introduced into a part of carboxyl groups of a (meth)acrylate polymer, for example, a (meth)acrylic copolymer (“Cyclomer P”, available from Daicel-Allnex Ltd.) in which a polymerizable group (photopolymerizable unsaturated group) is introduced into a side chain by reacting an epoxy group of an epoxy group-containing (meth)acrylate (for example, 3,4-epoxycyclohexenylmethyl acrylate) with a part of carboxyl groups of a (meth)acrylic acid-(meth)acrylate copolymer.

The (meth)acrylic polymer having a polymerizable group is preferably combined with a urethane (meth)acrylate and/or a silicone (meth)acrylate, and is particularly preferably combined with a urethane (meth)acrylate and a silicone (meth)acrylate.

In a case where the (meth)acrylic polymer having a polymerizable group is combined with a urethane (meth)acrylate and/or a silicone (meth)acrylate, the ratio of the urethane (meth)acrylate is, for example, about from 10 to 300 parts by weight, preferably about from 100 to 200 parts by weight, and more preferably about from 120 to 180 parts by weight per 100 parts by weight of the (meth)acrylic polymer having a polymerizable group.

The ratio of the silicone (meth)acrylate is, for example, about from 0.1 to 10 parts by weight, preferably about from 0.5 to 5 parts by weight, and more preferably about from 1 to 3 parts by weight per 100 parts by weight of the (meth)acrylic polymer having a polymerizable group.

The curable composition may further include a cellulose ester in addition to the curable resin.

Examples of the cellulose ester include: cellulose acetates, such as cellulose diacetates and cellulose triacetates; cellulose C2-6 acylates, such as cellulose propionates, cellulose butyrates, cellulose acetate propionates, and cellulose acetate butyrates.

These cellulose esters can be used alone or in combination of two or more.

Among those, cellulose diacetates, cellulose triacetates, and cellulose C₂₋₄ acylates such as cellulose acetate propionates and cellulose acetate butyrates are preferred, and cellulose acetate C3-4 acylates such as cellulose acetate propionates are particularly preferred.

The ratio of the cellulose ester is, for example, about from 0.1 to 30 parts by weight, preferably from 0.5 to 20 parts by weight, more preferably from 1 to 10 parts by weight (particularly from 2 to 5 parts by weight) with respect to 100 parts by weight of the curable resin.

The curable composition may further include fine particles in addition to the curable resin.

Examples of the fine particles include: inorganic fine particles, such as silica particles, titania particles, zirconia particles, and alumina particles; organic fine particles, such as copolymer particles of a (meth)acrylic monomer and a styrene-based monomer, crosslinked (meth)acrylic polymer particles, and crosslinked styrene-based resin particles.

These fine particles can be used alone or in combination of two or more types.

Among these, crosslinked (meth)acrylic polymer particles or the like are widely used.

The mean particle size of the fine particles is, for example, about from 1 to 30 μm, preferably about from 10 to 30 μm, and more preferably about from 15 to 25 μm.

The ratio of the fine particles is, for example, about from 0.1 to 10 parts by weight, preferably about from 0.2 to 5 parts by weight, more preferably about from 0.3 to 3 parts by weight (particularly about from 0.4 to 1 parts by weight) per 100 parts by weight of the curable resin.

Note that according to an embodiment of the present invention, in a case where the curable resin (in particular, in a case where the curable resin is a combination of a (meth)acrylic polymer having a polymerizable group and a urethane (meth)acrylate and/or a silicone (meth)acrylate) is combined with a cellulose ester, a surface having an Rku and an Rt within the range mentioned above and a dynamic friction coefficient that is low can be formed without using fine particles.

In addition to the curable resin, the curable composition may contain commonly used additives, such as polymerization initiators, stabilizers (antioxidants, ultraviolet absorbing agents, etc.), surfactants, water-soluble polymers, fillers, cross-linking agents, coupling agents, coloring agents, flame retardants, lubricants, waxes, preservatives, viscosity modifiers, thickening agents, leveling agents, or antifoaming agents.

These additives can be used alone or in combination of two or more types.

When the curable composition is a photocurable composition, the photocurable composition may include a photopolymerization initiator as a polymerization initiator.

Examples of the photopolymerization initiator include acetophenones or propiophenones, benzyls, benzoins, benzophenones, thioxanthones, and acylphosphine oxides.

The photopolymerization initiator may include a typical photosensitizer or photopolymerization accelerator (for example, tertiary amines).

The ratio of the photopolymerization initiator is, for example, about from 0.1 to 10 parts by weight, preferably about from 0.5 to 5 parts by weight, and more preferably about from 1 to 3 parts by weight per 100 parts by weight of the photocurable resin.

The curable composition before curing may further contain a solvent.

Examples of the solvent include ketones, ethers, hydrocarbons, esters, water, alcohols, cellosolves, cellosolve acetates, sulfoxides, and amides.

In addition, the solvent may be a mixed solvent.

Among these solvents, it is preferable that ketones (such as acetone, methyl ethyl ketone, methyl isobutyl ketone, and cyclohexanone) are included, and a mixed solvent of ketones and alcohols (such as ethanol, isopropanol, butanol, and cyclohexanol) is particularly preferable.

The ratio of the solvent is, for example, about from 30 to 300 parts by weight, preferably about from 50 to 250 parts by weight, and more preferably about from 100 to 200 parts by weight per 100 parts by weight of the curable resin.

The average thickness of the single-layer film and the low-friction layer is, for example, about from 1 to 30 μm, preferably about from 3 to 20 μm, and more preferably about from 5 to 15 μm (particularly about from 8 to 10 μm).

Note that in the present specification and claims, the average thickness of the single-layer film and the low-friction layer can be measured by the method described in Examples below.

### Laminate

When the low-friction film is a laminate, it is sufficient that the low-friction layer is disposed on an outermost surface; while the laminate structure is not particularly limited, from the perspective of productivity, handling, or the like, a structure in which the low-friction layer is laminated on a substrate layer (a laminate of a substrate layer and a low-friction layer laminated on one surface of the substrate layer) is preferable.

While the material of the substrate layer is not particularly limited, and can be selected from various types of organic materials (thermoplastic resins, thermosetting resins, photocurable resins, or the like) or inorganic materials (glass, ceramics, metals, or the like), a transparent material is preferable when the substrate layer is used in a protective film for optical applications such as a touch panel display.

Examples of the transparent material include: inorganic materials, such as glass; organic materials, such as a cellulose ester, a polyester, a polyamide, a polyimide, a polycarbonate, and a (meth)acrylic polymer.

Among those, the cellulose ester, the polyester, and the like are widely used.

Examples of the cellulose ester include cellulose acetate such as cellulose triacetate (TAC), and cellulose acetate C₃₋₄ acylate such as cellulose acetate propionate and cellulose acetate butyrate.

Examples of the polyester include polyalkylenearylates such as polyethylene terephthalate (PET) and polyethylene naphthalate (PEN).

Among those, poly C₂₋₄ alkylene C₈₋₁₂ arylates such as PET and PEN are preferred from the perspective of having an excellent balance in mechanical properties, transparency, or the like.

The substrate layer formed of polyester may be a uniaxially or biaxially stretched film, but may also be an unstretched film from the perspective of having a low birefringence and excellent optically isotropic properties.

The substrate layer may be subjected to surface treatment (for example, corona discharge treatment, flame treatment, plasma treatment, ozone or ultraviolet irradiation treatment, or the like), and may have an easily adhesive layer.

An average thickness of the substrate layer may be 10 μm or greater, for example, about from 12 to 500 μm, preferably about from 20 to 300 μm, and more preferably about from 30 to 200 μm.

### Adhesive Layer

The low-friction film according to an embodiment of the present invention may have an adhesive layer formed on at least a portion of the back surface (such as the back surface of the low-friction film in the single-layer film, the surface of the substrate layer, or the like) opposite the surface on which concavo-convex structures with Rku and Rt being within the range mentioned above are formed.

The low-friction film having an adhesive layer formed on the back surface can also be used as a protective film on a touch panel display such as that of a smart phone or a tablet PC.

The adhesive layer is formed of a typical transparent adhesive.

Examples of the adhesive include rubber-based adhesives, acrylic-based adhesives, olefin-based adhesives (such as modified olefin adhesives), and silicone-based adhesives.

These adhesives can be used alone or in combination of two or more types.

Among these adhesives, silicone adhesives are preferable from the perspective of optical properties, reworkability, or the like.

The average thickness of the adhesive layer is, for example, about from 1 to 150 μm, preferably about from 10 to 100 μm, more preferably about from 20 to 70 μm (particularly about from 25 to 50 μm).

The adhesive layer may be formed on the entire back surface, or may be formed on a portion (for example, a peripheral portion) of the back surface.

Further, in a case where the adhesive layer is formed on the peripheral portion, in order to improve the handling during adhering, the adhesive layer can be formed on a frame-like member which is formed on the peripheral portion of the low-friction film (for example, a plastic sheet laminated on the peripheral portion).

### Method of Producing Low-Friction Film

The method for producing the low-friction film according to an embodiment of the present invention is not particularly limited as long as it is a method that can form concavo-convex structures, of which the Rku and Rt are adjusted to be within the range mentioned above, on a surface, and the method can be appropriately selected depending on the material of the low-friction film.

Specific production methods include, for example, a method that includes curing a curable composition containing a curable resin (for example, a method of curing a curable composition including fine particles and making the fine particles to protrude above the surface, a method of curing a curable composition containing a resin component that can be phase-separated after phase-separating the resin component, or the like); a method of transferring concavo-convex structures using a mold having concavo-convex structures on a surface, a method of forming concavo-convex structures by cutting (for example, cutting using lasers or the like), a method of forming concavo-convex structures by polishing (for example, sand blasting method, bead shot method, or the like), a method of forming concavo-convex structures by etching.

Among these methods, from the perspective of producing a low-friction film with high productivity of which the Rku and Rt of the concavo-convex structures of a surface are adjusted to be within the range mentioned above, the method that includes curing a curable composition containing a curable resin is preferable; for example, the method may include coating a liquid curable composition on a substrate (when the low-friction film is a laminate, the substrate layer constituting the low-friction film) and drying the coating, and then curing the coating.

Examples of the coating method include typical methods such as coater methods, which include the roll coater method, the air knife coater method, the blade coater method, the rod coater method, the reverse coater method, the bar coater method, the comma coater method, the dip squeeze coater method, the die coater method, the gravure coater method, the micro gravure coater method, and the silk screen coater method, as well as a dipping method, a spraying method, and a spinner method.

Among these methods, the bar coater method or the gravure coater method are widely used.

If necessary, the coating solution may be applied a plurality of times.

The drying temperature is, for example, about from 30 to 120° C., preferably about from 50 to 110° C., more preferably about from 60 to 100° C. (particularly about from 70 to 90° C.).

The drying time is, for example, about from 0.1 to 10 minutes, preferably about from 0.3 to 5 minutes, and more preferably about from 0.5 to 3 minutes.

The curing method may be any method that providing active radiation (ultraviolet rays, electron beams, or the like), heat, or the like depending on the type of the curable resin. In the case of a photocurable resin, the photoirradiation can be selected depending on the type of the photocurable resin, and typically, ultraviolet rays, electron beams, or the like can be used.

A general-purpose exposure source is usually an ultraviolet irradiation device.

Examples of the light source include a deep UV lamp, a low-pressure mercury lamp, a high-pressure mercury lamp, an ultrahigh-pressure mercury lamp, a halogen lamp, and a laser light source (light source such as a helium-cadmium laser and an excimer laser) in the case of the ultraviolet rays.

The amount of irradiation light (irradiation energy) varies depending on the thickness of the coating film, and is, for example, about from 10 to 10000 mJ/cm², preferably about from 20 to 5000 mJ/cm², and more preferably about from 30 to 3000 mJ/cm².

As necessary, the light irradiation may be performed in an inert gas atmosphere.

In such method of curing a curable composition, examples of a method of forming concavo-convex structures which imparts the Rku and Rt adjusted to be within the range mentioned above to a surface include: a method of blending fine particles in the curable composition, making the fine particles to protrude, and curing the curable composition (a method using fine particles); a method of blending a resin component that can be phase-separated into the curable composition and curing the resin component after phase separation (a method using phase separation).

In the method that uses fine particles, the concavo-convex structures can be formed on a surface by curing the curable composition with fine particles protruded from the surface.

In the method that uses phase separation, phase separation by spinodal decomposition (wet spinodal decomposition) may occur along with the concentration of the composition during the process of evaporating or removing the solvent, by drying or the like, from the liquid phase of the composition including the resin component that can be phase-separated and the solvent, forming concavo-convex structures on a surface with relatively regular correlation distances (phase separation structure).

Examples of methods that use phase separation include the methods described in JP 2007-187746 A, JP 2008-225195 A, JP 2009-267775 A, JP 2011-175601 A, and JP 2014-85371 A.

The combination of resin components that can be phase-separated is preferably a combination of a (meth)acrylic polymer having a polymerizable group, a urethane (meth)acrylate, a silicone (meth)acrylate, and a cellulose ester.

### EXAMPLE(S)

Hereinafter, the present invention is described in greater detail based on examples, but the present invention is not limited to these examples.

The raw materials used in Examples and Comparative Examples are as follows, and the low-friction film obtained was evaluated by the following method.

### Raw Material

Acrylic-based polymer A having a polymerizable group: “KRM8713B”, available from Daicel-Allnex Ltd.

Acrylic-based polymer B having a polymerizable group: “Cyclomer P”, available from Daicel-Allnex Ltd.

Acrylic-based polymer: “8KX-078”, available from Taisei Fine Chemical Co., Ltd.

Urethane modified co-polyester resin: “Vylon (trade name) UR-3200”, available from Toyobo Co., Ltd.

Cellulose acetate propionate: “CAP-482-20”, available from Eastman Chemical Company, degree of acetylation=2.5%, degree of propionylation=46%, number average molecular weight calibrated with polystyrene is 75000

Urethane acrylate: “UA-53H” available from Shin-Nakamura Chemical Co., Ltd.

Silicone acrylate: “EBECRYL 1360”, available from Daicel-Allnex Ltd.

PMMA Beads A: “SSX-115”, available from Sekisui Chemical Co., Ltd., average particle size 15 μm

PMMA Beads B: “SSX-110”, available from Sekisui Chemical Co., Ltd., average particle size 10 μm

Acrylic-based ultraviolet (UV) curable compound containing nano-silica: “Z7501”, available from JSR Corporation

Photoinitiator A: “Irgacure 184” available from BASF Japan Ltd.

Photoinitiator B: “Irgacure 907” available from BASF Japan Ltd.

Polyethylene terephthalate (PET) film: “DIAFOIL” available from Mitsubishi Plastics, Inc.

### Thickness of Low-Friction Layer

Using an optical film thickness gauge, ten arbitrary points were measured, and an average value was calculated.

### Surface Topography

In accordance with JIS B0601, using an optical surface roughness meter (“VertScan R5500G” available from Hitachi High-Tech Science Corporation), the total height (Rt) and the kurtosis (Rku) of the concavo-convexes were measured under the conditions of a scanning range of a 2.5 mm square and a scanning count of 2.

Dynamic friction coefficient and relative dynamic friction coefficient

Dynamic friction force (dynamic friction coefficient) was measured under measurement conditions (a load of 20 g and a speed of 25 mm/seconds) using a static and dynamic friction measuring machine (“Handy Tribomaster TL201Ts”, available from Trinity-Lab. Inc.).

As the contact probe, an artificial skin (“BIOSKIN”, available from Beaulux Co., Ltd.) was attached to a sponge sheet (“Sukima-Yo Tape N-1” manufactured by Cemedine Co., Ltd.) having a thickness of 5 mm.

The relative dynamic friction coefficient was determined by dividing the dynamic friction force of the film, which is the subject of the measurement, by the dynamic friction force measured using glass (soda lime glass) as a specimen.

### Finger Slidability

The evaluation of finger slidability was performed as follows: The obtained low-friction film was attached to an acrylic plate on the substrate layer side using an optical clear adhesive (OCA) film having a thickness of 25 μm, to prepare a testing piece. Evaluation was carried out by sliding an index finger on the surface of the film (low-friction layer) of the test piece in the manner of operating a smartphone.

The evaluation results were interviewed on 20 subjects according to the following five tiered criteria.

One point: the finger does not slide very well, and the finger catches during operation

Two points: the finger catches at the onset of sliding, and feels high friction after sliding starts

Three points: the finger catches at the onset of sliding, but feels low friction after sliding starts

Four points: the finger slightly catches at the onset of sliding, but feels no friction during operation

Five points: the finger does not catch at the onset of sliding, and feels no friction during operation.

### Example 1

216 parts by weight of the acrylic-based polymer A having a polymerizable group, 1 part by weight of the PMMA beads A, 1 part by weight of the photoinitiator A, and 1 part by weight of the photoinitiator B were dissolved in 117 parts by weight of methyl ethyl ketone.

The solution was cast on a PET film using a wire bar #14, and then was left in an oven at 100° C. for 1 minute to evaporate the solvent and a low-friction layer having a thickness of about 12 μm was formed.

Then, the low-friction layer was irradiated with ultraviolet rays from a high-pressure mercury lamp for about 5 seconds (total irradiation dose of about 100 mJ/cm²) and subjected to UV curing treatment, and a low-friction film was obtained.

### Example 2

50 parts by weight of the acrylic-based polymer B having a polymerizable group, 4 parts by weight of the cellulose acetate propionate, 76 parts by weight of the urethane acrylate, 1 part by weight of the silicone acrylate, 1 part by weight of the photoinitiator A, and 1 part by weight of the photoinitiator B were dissolved in a mixed solvent of 176 parts by weight of methyl ethyl ketone and 28 parts by weight of 1-butanol.

The solution was cast on a PET film using a wire bar #18, and then was left in an oven at 80° C. for 1 minute to evaporate the solvent and a low-friction layer having a thickness of about 9 μm was formed.

Then, the low-friction layer was irradiated with ultraviolet rays from a high-pressure mercury lamp for about 5 seconds (total irradiation dose of about 100 mJ/cm²) and subjected to UV curing treatment, and a low-friction film was obtained.

### Comparative Example 1

216 parts by weight of the acrylic-based polymer A having a polymerizable group, 1 part by weight of the PMMA beads B, 1 part by weight of the photoinitiator A, and 1 part by weight of the photoinitiator B were dissolved in 117 parts by weight of methyl ethyl ketone.

The solution was cast on a PET film using a wire bar #14, and then was left in an oven at 100° C. for 1 minute to evaporate the solvent and a low-friction layer having a thickness of about 8 μm was formed.

Then, the low-friction layer was irradiated with ultraviolet rays from a high-pressure mercury lamp for about 5 seconds (total irradiation dose of about 100 mJ/cm²) and subjected to UV curing treatment, and a low-friction film was obtained.

### Comparative Example 2

34.2 parts by weight of the acrylic-based polymer, 20 parts by weight of the urethane modified co-polyester resin, 166.3 parts by weight of the acrylic-based UV curable compound containing nano-silica, 0.2 parts by weight of the silicone acrylate, 1 part by weight of the photoinitiator A, and 1 part by weight of the photoinitiator B were dissolved in 179 parts by weight of methyl ethyl ketone.

The solution was cast on a PET film using a wire bar #16, and then was left in an oven at 80° C. for 1 minute to evaporate the solvent and a low-friction layer having a thickness of about 5 μm was formed.

Then, the low-friction layer was irradiated with ultraviolet rays from a high-pressure mercury lamp for about 5 seconds (total irradiation dose of about 100 mJ/cm²) and subjected to UV curing treatment, and a low-friction film was obtained.

### Comparative Example 3

PM-A15FLGM (available from ELECOM), a protective sheet for smartphones available in the market, was used as a comparative example of a film on which a finger slides well because it was proclaimed as an “ultimate finger sliding film” or a “super smooth film” on the package.

### Comparative Example 4

PM-A15FLST (available from ELECOM), a protective sheet for smartphones available in the market, was used as a comparative example of a film on which a finger slides well because it was proclaimed to facilitate “smooth finger sliding” or to be a “super smooth film” on the package.

Table 1 shows the results of evaluating the properties of the low-friction films obtained in Examples and Comparative Examples.

TABLE 1

| | Examples | | Comparative Examples | | | |
|---|---|---|---|---|---|---|
| Items | 1 | 2 | 1 | 2 | 3 | 4 |
| Total height Rt (μm) | 2.47 | 3.94 | 0.73 | 1.72 | 0.47 | 0.47 |
| Kurtosis Rku | 45.89 | 4.48 | 25.53 | 1.80 | 3.46 | 3.69 |
| Dynamic friction | 0.22 | 0.10 | >1.00 | 0.40 | 0.29 | 0.27 |
| coefficient | | | | | | |
| Relative dynamic | 0.28 | 0.13 | >1.27 | 0.51 | 0.37 | 0.34 |
| friction coefficient | | | | | | |
| Finger slidability | 4 | 5 | 1 | 2 | 3 | 3 |

As is clear from the results of Table 1, the low-friction films of the Examples had a low dynamic friction coefficient, a low relative dynamic friction coefficient, and a superior finger slidability.

Meanwhile, as in Comparative Examples 1, 3, and 4, the finger slidability does not increase when only the kurtosis is high.

Further, even when only the total height is large, as in Comparative Example 2, the finger slidability is inferior to that of the Examples.

### INDUSTRIAL APPLICABILITY

The low-friction film according to an embodiment of the present invention can be used as a surface-protecting or covering film for covering the surface of various molded articles such as touch panel displays of personal computers (tablet PCs, etc.) and smartphones, housings of consumer electronic products, building materials, or the like. In particular, the film is useful as a film that improves the tactile feel by imparting low friction to a part that is operated by hand touch.

1. A film having at least one surface having a kurtosis (Rku) of greater than or equal to 2 and a total height (Rt) of greater than or equal to 1 μm.

2. The film according to claim 1, wherein a dynamic friction coefficient of a surface is less than or equal to 0.25.

3. The film according to claim 1, wherein a relative dynamic friction coefficient of a surface is less than or equal to 0.3.

4. The film according to claim 1, wherein: the film includes a low-friction layer, the low-friction layer being formed of a cured product of a curable composition comprising a curable resin and being disposed on a outermost layer; a surface of the low-friction layer has a kurtosis (Rku) of greater than or equal to 2 and a total height (Rt) of greater than or equal to 1 μm.

5. The film according to claim 4, wherein the curable resin includes at least one selected from the group consisting of a (meth)acrylic polymer having a polymerizable group, a urethane (meth)acrylate, and a silicone (meth)acrylate.

6. The film according to claim 4, wherein the curable composition further includes a cellulose ester.

7. The film according to claim 4, wherein the curable composition includes no fine particle.

8. The film according to claim 4, wherein the low-friction layer is laminated on a substrate layer formed of a transparent resin.

9. The film according to claim 1, wherein the film has an abundance ratio of silicon atom at a surface of less than 10% and an abundance ratio of fluorine atom at a surface of less than 20%.

10. A method of producing the film described in claim 1, wherein the method includes curing a curable composition including a curable resin.

11. A molded article comprising the film described in claim 1 on a surface of the molded article.

12. The molded article according to claim 11, wherein the molded article is a touch panel display.

13. A method of improving finger slidability of a film, wherein the improving the finger slidability includes adjusting at least one surface of the film to have kurtosis (Rku) greater than or equal to 2 and the total height (Rt) greater than or equal to 1 μm.
